(19) United States
(12) Patent Application Publication
(10) Pub. No.: US 2025/0384239 A1
(43) Pub. Date: Dec. 18, 2025

(54) Method and Device for Reducing Computing Operations or Model Components of a GNN

(71) Applicant: Robert Bosch GmbH, Stuttgart (DE)

(72) Inventors: Max Keller, Berlin (DE); Maxim Dolgov, Renningen (DE)

(21) Appl. No.: 19/232,232

(22) Filed: Jun. 9, 2025

(30) Foreign Application Priority Data
Jun. 12, 2024 (DE) 10 2024 205 400.3

(51) Int. Cl. G06N 3/04

(52) U.S. Cl. CPC G06N 3/04

(57) ABSTRACT

A method for reducing computing operations or model components of a GNN includes (i) providing a GNN architecture in which distances and/or relative orientations between nodes can be modeled and processed in the form of edge features, (ii) providing discretization values of distances and/or relative orientations between nodes of a network graph of the GNN, (iii) encoding the discretization values into a latent space by an edge-feature encoder, (iv) performing retrievable and index-based storage of the encoded discretization values in a database; and (v) retrieving the encoded discretization values from the database by the GNN to reduce the computing operations or model components associated with the encoded discretization values.

This application claims priority under 35 U.S.C. § 119 to application no. DE 10 2024 205400.3, filed on Jun. 12, 2024 in Germany, the disclosure of which is incorporated herein by reference in its entirety.

The disclosure relates to a method and a device for reducing computing operations or model components of a GNN that may be implemented in particular in a system of a vehicle having an autonomous driving function.

### BACKGROUND

Graph Neural Networks (GNNs) have proven to be a promising technology for predicting and planning vehicle trajectories in automated driving. Their ability to model spatial relationships and interdependencies between different elements in the road environment makes them a powerful tool. In autonomous driving scenarios, roads and traffic networks can be represented as graphs, with vehicles, pedestrians and road infrastructure nodes acting as interconnected nodes.

GNNs utilize this graph structure to capture complicated interactions between vehicles, account for the impact of adjacent units, and make sound predictions of future trajectories. This capability is critical to predicting and responding to dynamic situations, such as when lanes, changes in traffic flow, or unexpected obstacles are merged. As a result, GNNs significantly contribute to improving the safety and efficiency of automated travel systems.

Despite their strengths, GNNs often have difficulty effectively encoding and understanding distances or spatial relationships in data. This is primarily because GNNs are designed to utilize the topological structure of graphs and focus on node features and their connectivity rather than the spatial and/or geometric relationships between nodes. In typical graph structures, the edges each represent relationships or interactions without explicitly encoding spatial arrangements. This limitation can interfere with the ability of GNNs to accurately predict trajectory and fully capture complex traffic situations.

One way to teach GNNs spatial and/or geometrical structures is to encode distances and/or relative orientations in the edges and to account for these encoded edge features in the update (message passing) step. With this method, GNNs can better process spatial information and react more accurately to the conditions of the road environment. This is important for the practice of automated travel where the accuracy and efficiency of trajectory planning is critical.

In order for neural networks to be practically used in the vehicle for automated driving, they should be highly efficient and have low latency. In order to achieve low latency, various technical methods are employed. This includes reducing parameters of the neural network as well as saving entire neural components at runtime through pre-calculations. These optimizations are critical to meeting the real-time demands of autonomous driving and ensuring smooth integration into driving systems.

Graph neural networks offer great potential to improve the safety and efficiency of automated travel systems through their ability to model complex spatial relationships and make precise trajectory predictions.

Thus, there are still challenges in spatial coding and the need for high efficiency and low latency, so that ways are desired to overcome these problems and make GNNs even more useful for autonomous driving.

It is a task of the disclosure to provide a method improved in this respect and/or a device improved in this respect, in particular for reducing model components of a GNN.

### SUMMARY

The task is solved by a method according to the features set forth below. The task is further solved by a device according to the features set forth below. The task is furthermore solved by a system according to the features set forth below.

According to a first aspect, a method for reducing computing operations or model components of a GNN is proposed, the method comprising the steps of:
providing a GNN architecture in which distances and/or relative orientations between nodes can be modeled and processed in the form of edge features;
providing discretization values of distances and/or relative orientations between nodes of a network graph of the GNN;
encoding the discretization values into a latent space by an edge feature encoder;
in particular, retrievable and index-based storage of the encoded discretization values in a database; and
retrieving the encoded discretization values from the database by the GNN or, based on indices used by the GNN, to reduce the computing operations or model components associated with the encoded discretization values.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without going beyond the scope of the method according to the disclosure.

According to a second aspect, a device is proposed for reducing computing operations or model components of a GNN, wherein the device has an evaluation and computation device configured to perform the following steps:
providing a GNN architecture in which distances and/or relative orientations between nodes can be modeled and processed in the form of edge features;
providing discretization values of distances and/or relative orientations between nodes of a network graph of the GNN;
encoding the discretization values into a latent space by an edge feature encoder;
in particular, retrievable and index-based storage of the encoded discretization values in a database; and
retrieving the encoded discretization values from the database by the GNN or, based on indices used by the GNN, to reduce the computing operations or model components associated with the encoded discretization values.

According to a third aspect, a system is proposed comprising a vehicle having a device and a database, wherein the database is arranged in the vehicle, in particular in the device, or wherein the database is arranged externally from the vehicle, and is communicatively connected to the device via a communication interface.

The explanations given for the method apply to the device and the system accordingly. In this regard, any linguistic modifications of features formulated in terms of the method can be reformulated for the device and the system in accordance with standard linguistic practice, without such formulations having to be explicitly listed here.

The present method and device for reducing (required) model components of a GNN is in particular used in a system implemented in a vehicle. The GNN employed preferably includes edge features representing distances and/or relative orientations. By reducing the model components, computing time can be saved. In other words, the present method and device lead to computation time reduction of a GNN that may be deployed in a system of a vehicle and that in particular uses encoded distances and/or relative orientations in the edges of the graph of the GNN. The GNNs are preferably used for prediction and/or planning in an autonomous driving function of the vehicle.

In the present case, the reduction of model components is achieved by a discretization of distances and/or relative orientations between nodes of a relatively modeled scene graph in the GNN. Discretization allows the encoded edge features to be calculated in particular in advance (offline). In an online version of the GNN deployed in the vehicle or a system comprising the GNN of a vehicle with an autonomous driving function, the encoded edge features may then be loaded from a memory inside the vehicle memory or requested from a memory inside the vehicle, such as a server, using a wireless connection.

Pre-calculating the encoded edge features saves critical computing time in online operation of the GNN that would be necessary to encode all the edge features. The pre-calculation is made possible by the presently proposed discretization. The pre-calculation discretizes continuous values or values pairs (distances and relative orientations) into discrete values.

The database or data store provided therewith is configured to store the discretized, encoded edge features and preferably assign them a respective index for unambiguous assignability. The database or the memory may be located in the vehicle with the autonomous driving function, which is to be at least supported by the GNN, or on an outsourced server.

As the number of elements is preferably only a product of possible discrete distances and relative orientation values, the total number of which is preferably less than 10000, no external storage may be necessary. If the database or the memory is located on a remote or external server, a communication device, in particular for wireless connection, between the server/cloud and the vehicle is preferred, through which the request or retrieval based on the non-encoded and non-discretized distance and orientation pairs or tuples is transmitted to the server/cloud and a response is transmitted back to the GNN in the form of encoded edge features. Alternatively, or in addition, it may be possible and preferred that a list of tuples be requested (in parallel).

In Graph Neural Networks (GNNs) used to model networks and their nodes, discretization values of distance and relative orientation between the nodes play an important role. Distances between nodes can be divided into discrete intervals to reduce the variability in distances and simplify calculations.

For example, distances in a network could be divided into intervals of 0-1, 1-2, 2-3, etc. Each of these intervals is then associated with a particular discretization value. These discrete values can be used as inputs to the GNN to model the relationships between the nodes based on their distances.

Relative orientations refer to the angles or directions between nodes in a network. These angles may also be divided into discrete intervals, for example 0-30°, 30-60°, 60-90°, etc. As with the distances, these intervals are then associated with certain discretization values that can be used as inputs to the GNN in order to model the spatial relationships between the nodes. By discretizing distances and relative orientations, GNNs can be trained and applied more efficiently as the complexity of the input data is reduced. This may also make it easier for the model to recognize patterns in the data and understand the relationships between the nodes.

In another aspect, it is proposed that the GNN has a graph-based neural network structure for deep learning, wherein the GNN preferably has a graph-based CNN or Graph Attention Network. In other words, the GNN may be realized, for example, by Graph Convolutions (GCNs) and/or Graph Attention Networks (GATs).

Graph-based Convolutional Neural Networks (Graph CNNs) are characterized by local aggregation, where information from adjacent nodes is aggregated in order to detect local patterns in the graph. The aggregation is preferably weighted, with edges having weights representing the strength of the connection between nodes.

This affects the aggregation of the node information. Graph CNNs are composed of multiple layers, each layer performing a convolution over the nodes and their neighbors in order to extract hierarchical features of the graph. After aggregation and convolution, activation functions such as ReLU and normalization techniques such as batch normalization are applied in order to model non-linear patterns and increase the stability of the training.

Graph Attention Networks (GATs) use attention mechanisms to calculate attention weights for each edge. This allows a different weighting of the information originating from adjacent nodes. Through self-attention, each node calculates its own attention weights based on its neighbors, allowing for flexible and adaptive aggregation of the node features.

GATs can use multiple attention heads in order to view and aggregate different aspects of the node relationships in parallel. This multi-head monitoring improves the model capacity and the ability to learn complex patterns. After calculating the attention weights and aggregation of the node features, non-linear transformations are applied in order to extract deep and meaningful features.

By using graph CNNs or GATs in a GNN, complex graph-based data structures can be effectively modeled and analyzed. These approaches allow for deeper insights into the relationships and interactions between nodes of a network, thus improving the performance of deep learning models on graph-based data.

In another aspect or implementation, it is proposed that the edge feature encoder has an MLP.

The use of an MLP (Multi-Layer Perceptron) in the edge feature encoder means that the features of the edges are processed by a multilayer neural network. An MLP preferably consists of multiple fully connected layers, each layer consisting of a particular number of neurons. These neurons perform weighted sums of the inputs and apply activation functions to enable non-linear transformations.

By using an MLP in the edge feature encoder, complex and non-linear relationships between the edge features can be captured and modeled. This increases the expressiveness of the encoder and allows the GNN to extract deeper and more meaningful features from the edge information. The MLP-based edge-feature encoder thus helps to improve the performance and accuracy of the entire graph neuronal network.

Various encoder forms for the discretizes distances and/or orientations could be employed. For example, distances and orientations may be encoded as respective pairs of individual encoder components. In a second step, the individual encoded features may be concatenated or fused by another encoder. In addition, different distance and/or orientation embedding architectures could be utilized. Exemplary sinusoidal position embeddings are to be mentioned here. These embeddings can be used before the encoder is used.

In another aspect, it is proposed that storing the encoded discretization values in the database has an assignment of an index value, for example a hash value, to each node-specific distance and relative orientation pair.

Distances and relative orientations between nodes of a network graph are discretized to translate into manageable and comparable values. These discretized values represent specific distances and angles in a quantized form.

The discretized values are stored in a database so that they can be accessed quickly and efficiently later on, allowing for efficient management and use of the encoded information, e.g., in a deployed system within the graphene neural network (GNN). Each pair of node-specific distance and relative orientation is assigned an unambiguous index value, for example, which may be a hash value and allows for quick assignment and recognition.

The hash value is calculated by a hash function that converts the discretized values into an unambiguous but more compact value. Assigning an index value ensures that the information is stored compactly and efficiently. The uniqueness of the hash value ensures that each pair of distance and relative orientation can be quickly identified and retrieved, accelerating processing in the GNN.

This approach facilitates the management of the discretized values and improves the efficiency and performance of the entire graph neural network by enabling quick assignment and access to the required information. For example, a hash map may be provided in the database or memory that outputs the index from the associated database based on a tuple of distances and orientations. Alternative methods for retrieval of discrete tuples are also possible.

In another aspect, it is proposed that retrieving the encoded discretization values occurs via a communication interface from a server or from a cloud.

The communication interface allows for efficient and reliable transfer of data between the server or cloud and the graph neural network (GNN). By utilizing a server or cloud, the encoded discretization values can be centrally stored and managed, providing better scalability and flexibility. This not only makes it easier to access the required data, but also to update and manage it.

The communication interface ensures that the data can be accessed in real time or near real time, improving the performance and responsiveness of the GNN. Moreover, this approach allows for seamless integration of data from various sources and usage within the GNN, thereby improving the overall performance and accuracy of the network.

In another aspect, it is proposed that the provision of discretization values of distances and/or relative orientations between nodes of the network graph of the GNN be performed uniformly or non-uniformly, in particular over multiple discretization stages, and/or dependent or independent of each other.

The discretization of distances and orientations need not be uniform. For example, discretization stages for small distances may have smaller distances than large distance discretization stages. Discretization values for distances and orientations also need not be independent from each other. For example, for vehicles in front (small relative orientation) that are close (small distance) may have much smaller discretization stages.

In another aspect, it is proposed that the GNN is used for prediction and/or planning in an autonomous driving function of a vehicle, wherein the prediction and/or planning is also based on the encoded distances and/or relative orientation included as edge features of the GNN, or benefit from encoded distances and/or relative orientations.

The GNN is preferably utilized to predict (prediction) future states and movements of the vehicle as well as its environment and assist in the creation of timetables and/or routes (planning) and/or trajectories to be driven, which allow the vehicle to be navigated safely and efficiently. It is integrated into the autonomous driving function of a vehicle to make complex decisions in real time.

This includes detecting traffic conditions, obstacles, and other vehicles, as well as adjusting the travel strategy accordingly. The distances between different objects or points in the surroundings of the vehicle are encoded and stored as discrete values. These encoded distances serve as important input data for the GNN to model the spatial relationships. In addition to the distances, the relative orientations (angles) between the nodes (e.g., objects or vehicles) are also encoded. These orientations are used as edge features in the GNN to account for the direction and orientation of objects.

The encoded distances and relative orientations are integrated as edge features in the GNN, allowing the network to precisely model the connections and interactions between the nodes in the graph. This methodology enables the GNN to perform more precise and robust predictions and plans for the autonomous travel function of a vehicle, which improves the ability of the vehicle to handle complex travel situations and navigate safely.

In a further aspect, a control unit is also disclosed which is comprised in a vehicle having an autonomous driving function and/or a robotic system and/or an industrial machine, and on which the present method is executable in one of its aspects.

In a further aspect, a computer program with program code is disclosed for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier with program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The described embodiments and refinements may be combined with one another as desired.

Further possible designs, refinements and implementations of the disclosure also include combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings.

The illustrated elements of the drawings are not necessarily shown to scale with respect to one another.

The figures show:

FIG. 1 shows a schematic flowchart of an exemplary embodiment of the present method;

FIG. 2 shows a schematic representation of distances and relative orientations between two nodes of a GNN; and

FIG. 3 shows a schematic block diagram of an exemplary embodiment of the device or a system.

In the figures of the drawings, identical reference numbers denote identical or functionally identical elements, parts or components, unless stated otherwise.

### DETAILED DESCRIPTION

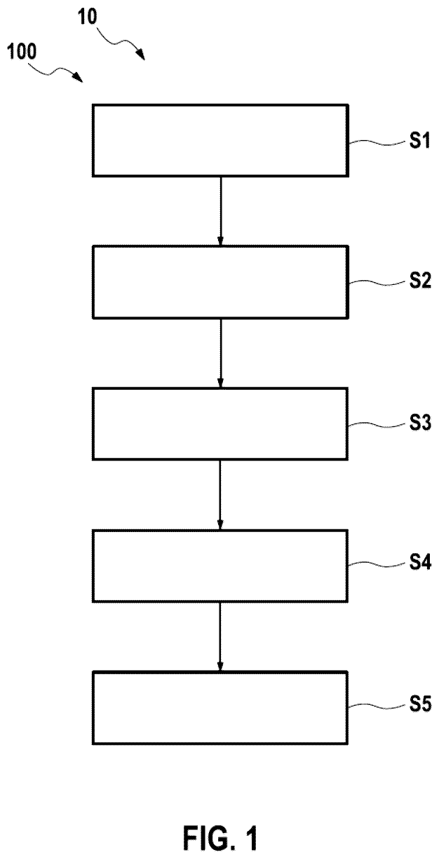

FIG. 1 shows a schematic flow chart of a method for reducing computing operations or model components of a GNN.

The method can be carried out in any embodiment, at least in part, by a device 10 which may comprise several components not shown in detail, for example one or more provision devices and/or at least one evaluation and computing device.

It is understood that the provision device may be configured together with the evaluation and computing device or may be different from it. Furthermore, the device 10, which may be part of a system 100, may comprise a storage device and/or an output device and/or a display device and/or an input device.

The method also includes at least the following steps:

In a step S1, a GNN architecture is provided in which distances and/or relative orientations between nodes in the form of edge features can be modeled and processed.

In a step S2, a discretization values of distances and/or relative orientations are provided between nodes of a network graph of the GNN.

In a step S3, the discretization values are encoded into a latent space by an edge feature encoder.

Steps S1 to S3 preferably take place offline.

In a step S4, in particular retrievable and index-based storage of the encoded discretization values occurs in a database.

In a step S5, the encoded discretization values are retrieved from the database by the GNN for reducing the computing operations or model components associated with the encoded discretization values.

Steps S4 and S5 preferably take place online.

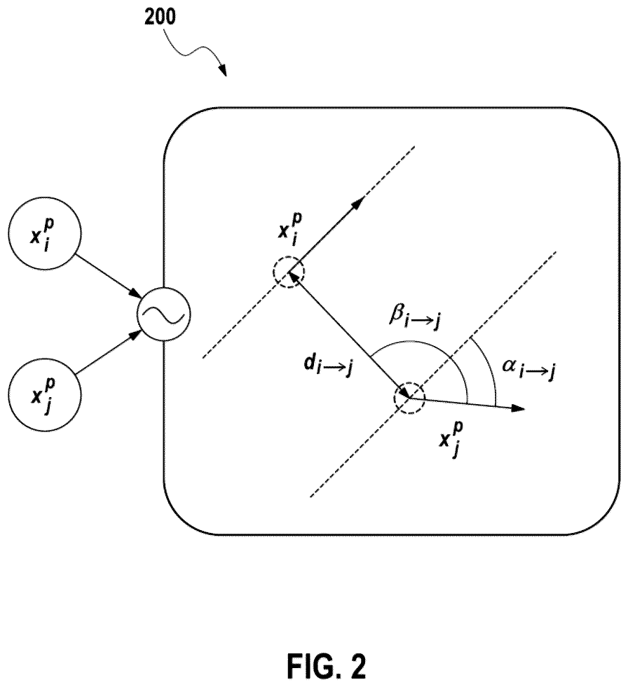

FIG. 2 shows a schematic representation of distances and relative orientations between two nodes x^{p}i, x^{p}j of a GNN 200. Here, a visual representation of the distances d_{i->j} and the relative orientations α_{i->j}, β_{i->j} between two nodes x^{p}i, x^{p}j is shown. The orientation α_{i->j} describes an orientation difference between the nodes x^{p}i, x^{p}j. The orientation β_{i->j} describes an orientation difference between the node x^{p}j and the directed distance d_{i->j}.

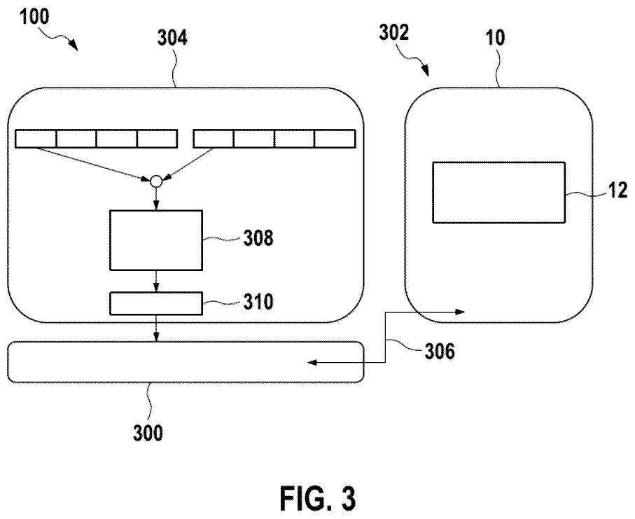

FIG. 3 shows a schematic block diagram of an exemplary embodiment of a system 100. Here, a database 300 is not located within a vehicle 302, but on an external server 304. The database 300 is queried via a, in particular wireless, communication interface 306 between a device 10 on which a GNN 12 is implemented that has reduced model components. A distance D=1 m and a relative orientation O=0.3 rad is selected as the exemplary discretization.

Preferably, on the server 304, an edge-feature encoder 308 is implemented that is configured to encode the edge features of the GNN 12. The edge features preferably each have pairs from a distance D and a relative orientation O between two nodes, so that these (D,O) tuples can be encoded from the edge feature encoder 308 into encoded (D,O) features 310 in order to be stored in the database 300 for subsequent feature mapping.

The communication interface 306 is configured to provide the (D,O) tuples included in GNN 12 to the server to provide the encoded edge features (DO) 310 provided by edge-feature encoder 308 to the model component-reduced GNN 12 and to provide the encoded (D,O) features 310 to the model component-reduced GNN 12.

What is claimed is:

1. A method for reducing computing operations or model components of a GNN, comprising:
providing a GNN architecture in which distances and/or relative orientations between nodes are modeled and processed in the form of edge features;
providing discretization values of distances and/or relative orientations between nodes of a network graph of the GNN;
encoding the discretization values into a latent space by an edge feature encoder;
performing retrievable and index-based storage of the encoded discretization values in a database; and
retrieving the encoded discretization values from the database by the GNN based on indices used by the GNN to reduce the computing operations or model components associated with the encoded discretization values.

2. The method according to claim 1, wherein the GNN has a graph-based neural network structure for deep learning.

3. The method according to claim 1, wherein storing the encoded discretization values in the database comprises assigning an index value to each node-specific distance and relative orientation pair.

4. The method according to claim 1, wherein retrieving the encoded discretization values from a server or from a cloud occurs via a communication interface.

5. The method according to claim 1, wherein the provision of discretization values of distances and/or relative orientations between nodes of the network graph of the GNN is performed uniformly or non-uniformly over multiple discretization stages, and/or dependent or independent of each other.

6. The method according to claim 1, wherein the GNN is used for prediction and/or planning in an autonomous driving function of a vehicle, and wherein the prediction and/or planning is also based on the encoded distances and/or relative orientation included as edge features of the GNN.

7. A computer program with program code to execute at least portions of a method according to claim 1 if the computer program is executed on a computer.

8. A computer-readable data carrier with program code of a computer program to execute at least portions of a method according to claim 1 if the computer program is executed on a computer.

9. A device for reducing computing operations or model components of a GNN, wherein the device has an evaluation and computation device configured to perform the following:
providing a GNN architecture in which distances and/or relative orientations between nodes are modeled and processed in the form of edge features;
providing discretization values of distances and/or relative orientations between nodes of a network graph of the GNN;
encoding the discretization values into a latent space by an edge-feature encoder;
performing retrievable and index-based storage of the encoded discretization values in a database; and
retrieving the encoded discretization values from the database by the GNN based on indices used by the GNN to reduce the computing operations or model components associated with the encoded discretization values.

10. A system comprising a vehicle having (i) a device according to claim 9, and (ii) a database, wherein:
the database is arranged in the vehicle, or
the database is arranged externally from the vehicle, and is communicatively connected to the device via a communication interface.

11. The method according to claim 2. wherein the GNN has a graph-based CNN or Graph Attention Network.

12. The method according to claim 3. wherein the index value is a hash value.

13. The system according to claim 10. wherein the database is arranged in the device.
